(19) United States
(12) Patent Application Publication
(10) Pub. No.: US 2025/0347534 A1
(43) Pub. Date: Nov. 13, 2025

(54) MECHANICAL SENDING UNIT BASE

(71) Applicant: Scott Snyder Porta, New Smyrna Beach, FL (US)

(72) Inventor: Scott Snyder Porta, New Smyrna Beach, FL (US)

(21) Appl. No.: 19/203,800

(22) Filed: May 9, 2025

Related U.S. Application Data
(60) Provisional application No. 63/645,678, filed on May 10, 2024.

(51) Int. Cl. G01D 5/04; B63H 20/06

(52) U.S. Cl. CPC G01D 5/04; B63H 20/06; G01D 2205/20

(57) ABSTRACT

A mechanical sending unit base configured for integration with a hinge assembly, such as those used in hydraulic transom brackets like the Porta Bracket. The system can comprise a stationary component affixed to the hinge, a movable component configured to rotate in correspondence with the hinge's motion, and a converter that captures and translates this motion into digital signals. The movable component may include a protrusion received by a converter receptacle, enabling rotation about a shared central axis. The converter may include a sensor that translates arc-length movement into machine-readable data compatible with NMEA 2000 networks. The stationary component may comprise an aperture patterns for simplified, non-invasive mounting. As a result, the base enables real-time positional feedback of hinge motion without modifying existing hinge/product geometry and is suitable for marine environments due to its corrosion-resistant construction.

### CROSS REFERENCE TO RELATED APPLICATION

This application claims the benefit under 35 U.S.C. § 119 (e) to a U.S. Provisional Patent Application having Ser. No. 63/645,678 filed on May 10, 2024. The above application is incorporated by reference herein in its entirety.

### BACKGROUND

### Field

The present disclosure relates generally to the field of marine equipment and vessel outfitting. More specifically, it pertains to hinge systems, transom-mounted components, and mechanical signal translation devices for watercraft. This disclosure further involves apparatuses and devices associated with motion tracking, positional sensing, and data communication in marine applications, particularly as they relate to bracket assemblies used in powerboats and similar watercraft.

### Description of the Related Art

Hydraulic transom brackets have become a cornerstone of high-performance marine propulsion systems, enabling precise vertical adjustment of outboard motors to optimize performance across varying speeds, loads, and water conditions. Among these, the Porta Bracket (as depicted in FIG. 9) has established itself as a premier solution—widely recognized for its robust construction, smooth vertical travel, and innovative parallelogram, trapezoidal, and rhomboid hinge system designs. These unique geometries allow for precise articulation and load distribution, making the Porta Bracket one of the only systems of its kind capable of supporting powerful engines while delivering both performance and reliability.

Despite its commercial and mechanical success, the Porta Bracket and similar transom lifting systems (of which there are few), face significant limitations in terms of positional sensing and data integration. As onboard marine electronics increasingly rely on real-time feedback and centralized data aggregation, particularly through the NMEA 2000 network, users and manufacturers alike have sought to interface transom machinery and components angular or positional information with these platforms. However, existing hinge assemblies used in hydraulic transom brackets lack a built-in mechanism or standard interface for capturing and converting angular motion into machine-readable data.

Furthermore, retrofitting conventional sending units to these hinge geometries has proven to be non-trivial. The unique form factors and motion paths of the hinge assemblies are not easily compatible with off-the-shelf sensors, and any attempt at adaptation typically requires permanent modifications such as drilling or welding. These interventions not only compromise the integrity and corrosion resistance of the bracket/hinge mechanisms but also introduce complexity and cost, deterring many users from pursuing positional feedback altogether.

As a result, boat operators remain unable to digitally track or automate bracket position alongside other key vessel parameters such as engine trim, RPM, or GPS heading—despite the technological demand for such capabilities. The absence of a simple, non-invasive way to convert mechanical bracket movement into NMEA 2000-compatible data represents a clear gap in the current marine technology ecosystem. This gap limits the potential of even the most sophisticated bracket systems by preventing seamless integration into the modern marine data environment.

### SUMMARY

The present disclosure provides for an apparatus and system that enables accurate, non-invasive positional sensing of hinge assemblies used in hydraulic transom brackets such as the Porta Bracket. Specifically, the present disclosure provides for an apparatus and system that can be retrofitted onto existing hinge geometries without structural modification, while also providing real-time positional feedback compatible with industry-standard marine data networks such as NMEA 2000. Therefore, the present disclosure provides for an apparatus and system that significantly enhances the usability and integration of hydraulic bracket sensors, allowing for digital monitoring, automation, and diagnostic capabilities that are currently absent from advanced bracket assemblies.

Therefore, the present disclosure provides for a mechanical sending unit base comprising a stationary component and a movable component where the stationary component can be immovably affixed to a hinge assembly, and where the movable component may be partially nestled within the stationary component and covered by a converter. The stationary component may become immovably affixed to a hinge assembly via at least one fastener. That said, the stationary component may also comprise an aperture pattern that matches a pre-existing aperture pattern on a hinge assembly (such as an aperture pattern on a Porta Bracket). Continuing, a washer may be interposed between the stationary component and the hinge assembly when the stationary component is immovably affixed to the hinge assembly via at least one fastener. Naturally, the washer may have an aperture pattern that matches that of the stationary component and hinge assembly.

The movable component may comprise an arm that can be configured and dimensioned to affix to a portion of the hinge assembly, the arm also comprising a receiver. The receiver may comprise a specific dimensioning or pattern that can allow a converter protrusion to be inserted into the receiver, where the converter protrusion can comprise a corresponding dimensioning or pattern to accommodate such insertion. Notably, the stationary component may comprise converter attachment points that may allow the converter to affix to the stationary component and cover the movable component when affixed to the stationary component.

When a portion of the hinge assembly rotates about a central axis (such as when a lift or Porta Bracket is adjusted to raise or lower a motor), the arm allows the receiver to rotate about the central axis at an arc length equal to the portion of the hinge assembly's rotation about the central axis. Consistent with such rotation, when a portion of the hinge assembly rotates about the central axis (which causes the arm to allow the receiver to rotate about the central axis at an arc length equal to the portion of the hinge assembly's rotation about the central axis), the converter protrusion rotates about the central axis at an arc length equal to the portion of the hinge assembly's rotation about the central axis. The converter can thus comprise a sensor that can be configured to measure an arc length when the converter protrusion rotates about the central axis and convert the arc length to machine readable data. The machine-readable data may be read on a NMEA 2000 network and may be converted to determine positioning of a motor about a transom device or hydraulic device's path of travel for a motor (such as the maximum and minimum lift positionings of a motor a Porta Bracket is able to provide for). Notably, the stationary component, movable component, and converter can comprise bodies made of rigid plastic. Otherwise the bodies of the stationary component, movable component, and converter can be formed of a corrosion-resistant material suitable for marine environments, which may be rigid plastic.

Also, the present disclosure provides for a mechanical sending unit base comprising a stationary component and a converter, a movable component nestled between the stationary component and converter, a central axis upon which a receiver of the movable component and a converter protrusion of the converter may rotate about. The stationary component may be immovably affixed to a hinge assembly. Further, the stationary component may comprise a track about which the movable component may move about. This track may define the points or limits at which the movable component may move and/or rotate about.

The receiver of the movable component may receive the converter protrusion of the converter, where the movable component may also comprise an arm that can be configured and dimensioned to affix to a portion of the hinge assembly. As a result, when a portion of the hinge assembly rotates about the central axis at an arc length, the arm rotates about the central axis wherein the receiver, and consequentially, the converter protrusion, rotate an arc length equal in distance as the arc length rotated by the hinge assembly. As such, the convert can comprise a sensor configured to convert an arc length traveled by the converter protrusion into machine readable data that may be read on a NMEA 2000 network. As may be apparent, a Porta Bracket may comprise the hinge assembly described herein.

### BRIEF DESCRIPTION OF THE DRAWINGS

For a fuller understanding of the nature of the present disclosure, reference should be had to the following detailed description taken in connection with the accompanying drawings in which:

FIG. 1 is a front view of an exploded mechanical sending unit base.

FIG. 2 is an alternative front view of an exploded mechanical sending unit base.

FIG. 3 is a front view of a mechanical sending unit base installed on a hinge assembly.

FIG. 4 is a side view of a mechanical sending unit base installed on a hinge assembly.

FIG. 5 is an alternative side view of a mechanical sending unit base installed on a hinge assembly.

FIG. 6 is a top view of a portion of mechanical sending unit base installed on a hinge assembly.

FIG. 7 is a front view of a partially disassembled mechanical sending unit base.

FIG. 8 is a front view of a portion of a mechanical sending unit base.

FIG. 9 is a depiction of prior art, namely, a Porta Bracket.

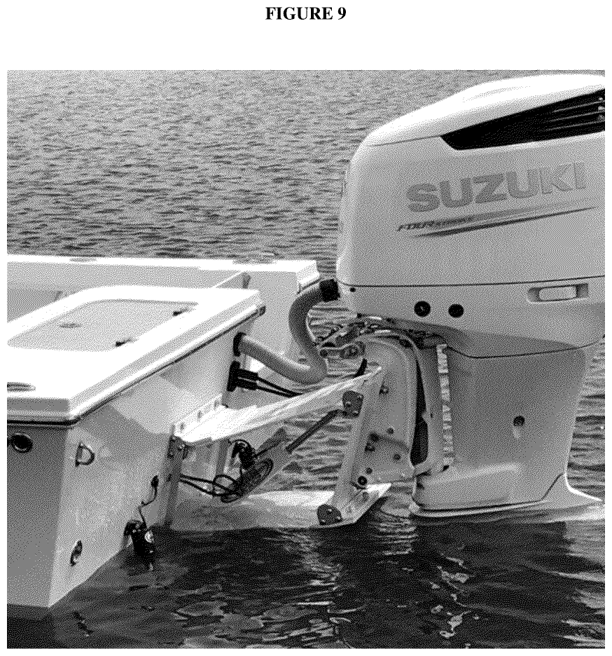

Like reference numerals refer to like parts throughout the several views of the drawings.

### DETAILED DESCRIPTION

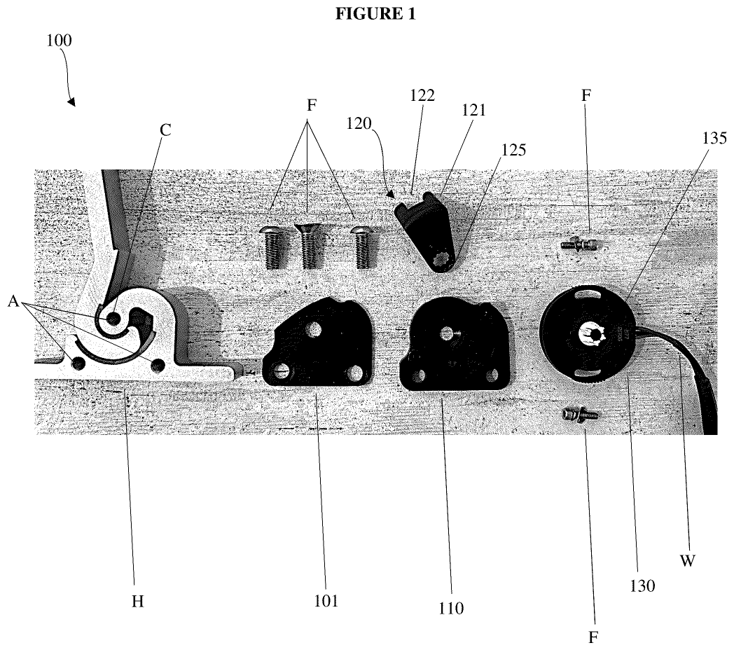

Turning now descriptively to the figures, FIG. 1 is a front view of an exploded mechanical sending unit base 100 and various components that can make up a mechanical sending unit base 100. As such, a hinge assembly H can be seen, which can be part of a hydraulic transom bracket such as a Porta Bracket, or another similar lifting mechanism used to vertically actuate an outboard motor on a watercraft. Notably, the hinge assembly H depicted in FIG. 1 may represent only a portion of a larger system, wherein additional mechanical and hydraulic elements (not shown) may connect the hinge assembly to a transom plate, motor mounting bracket, or power transmission components that collectively enable the raising and lowering of a marine engine.

The hinge assembly H can comprise a surface with an aperture pattern A, which may include a series of threaded or unthreaded bores configured and dimensioned to receive fasteners (or portions of the mechanical sending unit base 100). More specifically, these apertures may correspond with attachment points on the stationary component 110 of the mechanical sending unit base 100, allowing it to be secured immovably to the hinge assembly H during installation. Notably, the aperture pattern A may be pre-existing on a stock/unmodified hinge assembly H, such as that found on a Porta Bracket, thereby eliminating the need for additional drilling or machining during retrofit, although aperture patterns A may be added to existing hinge assemblies H.

Further, a central axis C is also depicted in FIG. 1, corresponding to the rotational axis about which a portion of the hinge assembly H—and, by mechanical interface, the movable component 120 and converter 130 of the sending unit base 100—may pivot. This axis C may thus serve as a functional reference point for the arc of travel that the sending unit base 100 may measure and transmit as data.

It should be understood that the hinge assembly H and all components of the base 100—can be fabricated from marine-grade materials suitable for exposure to moisture, salt, vibration, and temperature fluctuation. In some embodiments, these components may be made from anodized aluminum, stainless steel, or corrosion-resistant polymer composites, such as reinforced nylon or marine-grade thermoplastics. These materials can provide the necessary balance of rigidity, environmental durability, and lightweight properties essential for marine applications.

To the right of the hinge assembly H, a washer 101 can be seen. The washer 101 may be generally disc-shaped and comprises an aperture pattern A that corresponds with that of the hinge assembly H, allowing it to align precisely during installation. The washer 101 may thus take on other shapes so as to correspond to a shape of the hinge assembly H, stationary component 110, and/or aperture pattern A thereof. The washer 101 can be dimensioned to be interposed between the hinge assembly H and the stationary component 110 of the mechanical sending unit base 100 when affixed via at least one fastener F (as is depicted and as will be described). In such positioning, the washer 101 may serve multiple purposes: (1) distributing the compressive load imparted by the fastener F to prevent damage to the hinge assembly H or stationary component 110; (2) reducing potential frictional wear between the hinge assembly H and the stationary component 110 during installation and use; and (3) aiding in the preservation of any corrosion-resistant finishes on the hinge assembly H by acting as a barrier layer.

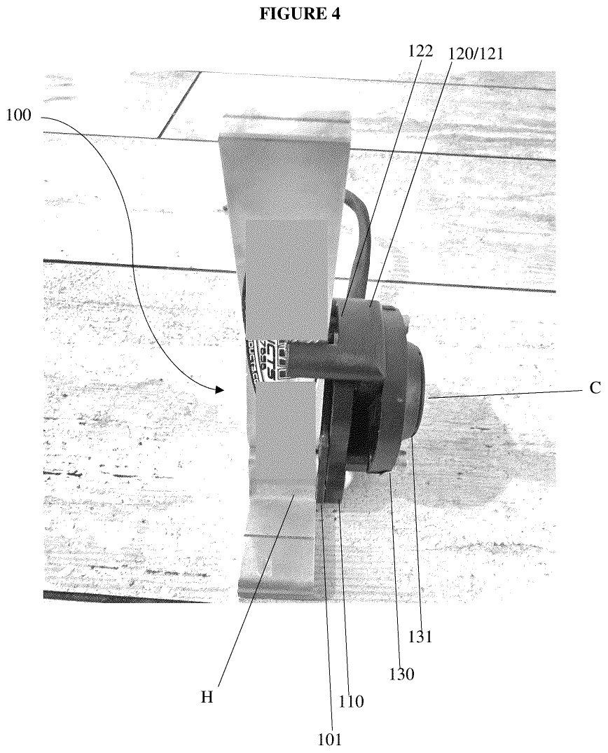

With further reference to FIG. 1, positioned to the right of the washer 101 is the stationary component 110 of the mechanical sending unit base 100 (where fasteners F are above the washer 101). The stationary component 110 may be generally planar or slightly contoured depending on the hinge assembly H to which it is mounted, and it may include one or more converter attachment points 112 and a track 111, each of which will be described further herein. The stationary component 110 may be configured and dimensioned to mount flush (references FIGS. 4-6) against the hinge assembly H, with the washer 101 interposed therebetween. As noted, the stationary component 110 may comprise an aperture pattern A that corresponds to that of the washer 101 and hinge assembly H, allowing for proper alignment and securement when the components are assembled.

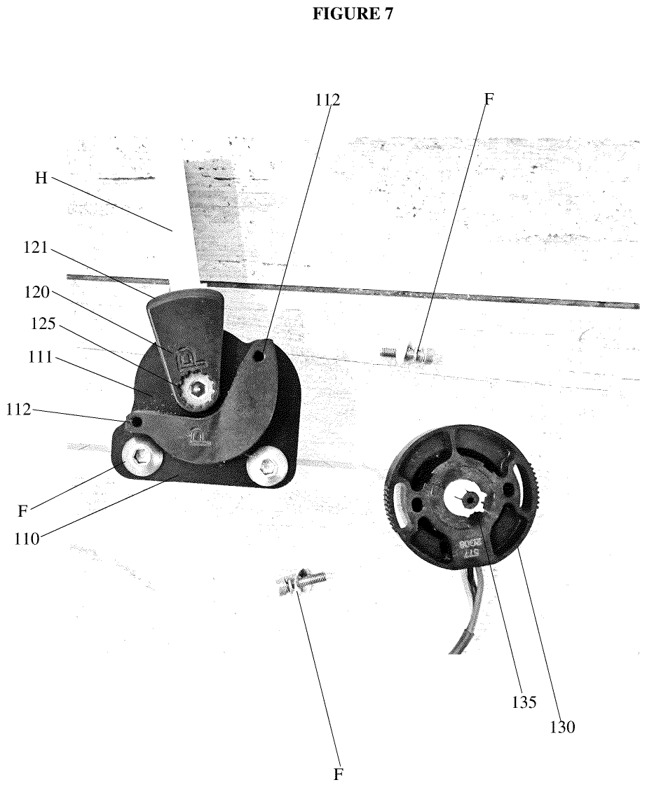

Fasteners F can thus be used to extend through the aperture pattern A of the stationary component 110 (reference may be had to FIG. 7). Each fastener F may be a threaded bolt, machine screw, or other mechanical securing element capable of locking the stationary component 110, washer 101, and hinge assembly H into a rigidly affixed arrangement (again, reference may be had to FIG. 7 for a depiction of the described orientation). The fasteners F may be secured using threaded inserts or nuts positioned behind the hinge assembly H or formed integrally with the bracket's structure. These fasteners F may be formed of stainless steel or similarly non-corrosive material, and in some instances may include washers, locking mechanisms, or thread sealant to further secure the assembly and resist loosening due to vibration or environmental effects.

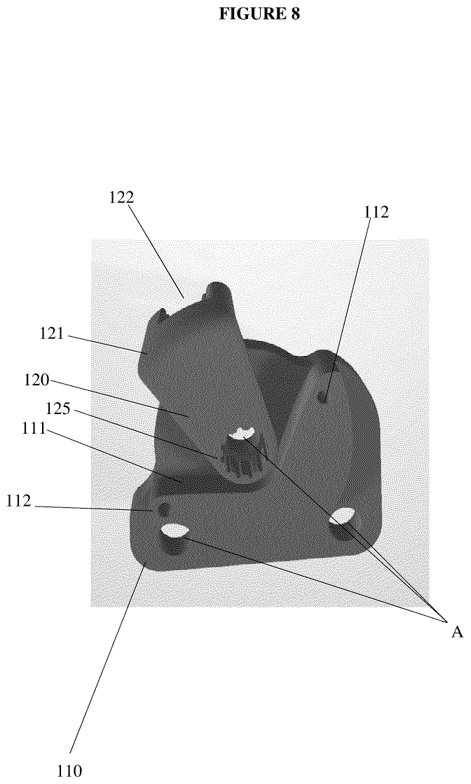

Above the stationary component 110 in FIG. 1 is the movable component 120 of the mechanical sending unit base 100. The movable component 120 may be configured and dimensioned to fit within the boundary defined by the track 111 of the stationary component 110, enabling controlled rotation about the central axis C when installed (reference may be had to FIGS. 7 and 8 for a depiction of the moveable component 120 within the track 111). The movable component 120 may include an arm 121 extending radially from a centerline of the component, the arm 121 serving as the primary structure through which the motion of the hinge assembly H is captured and translated.

The arm 121 may comprise a distal end configured comprising an arm notch 122 to affix to or interface with a rotating portion of the hinge assembly H. This interfacing may occur via direct physical attachment or by nesting into or overlaying a corresponding geometry or recess along the hinge assembly H that moves as the bracket articulates.

At the proximal end of the movable component 120—opposite the notch 122—is a receiver 125. The receiver 125 may be cylindrical, polygonal, or star-shaped and is configured and dimensioned to securely receive a converter protrusion 135 of the converter 130 (as will be described). The geometry of the receiver 125 may be complementary to the geometry of the converter protrusion 135 to ensure a secure, non-slipping interface. The receiver 125 and the converter protrusion 135 may be press-fit, keyed, or splined to enable accurate transmission of angular motion while minimizing backlash or relative movement between components.

When assembled within the stationary component 110 and covered by the converter 130, the movable component 120 is permitted to rotate along a limited arc path governed by the bracket's range of travel, thereby enabling the converter 130 to capture and translate this mechanical movement into digital data. As such, the track 111 may also define a limited arc path or length. Continuing with reference to FIG. 1, the converter 130 is depicted to the right of the movable component 120, and is shown in an orientation such that its converter protrusion 135 is visible. The converter 130 may serve as a protective housing and electronic interface for translating mechanical rotation into machine-readable data. It is configured and dimensioned to align with and cover the movable component 120 once the movable component 120 is installed within the stationary component 110, as previously described.

With further reference to FIG. 1, the converter 130 cam be seen. The converter 130 may further include one or more mounting holes for receiving fasteners F, which can be used to secure the converter 130 to the converter attachment points 112 on the stationary component 110. These fasteners F may be machine screws or threaded bolts, and may include sealing elements or locking features to maintain watertight integrity and prevent loosening due to vibration.

In FIG. 1, projecting from the converter 130 is the converter protrusion 135, which is configured and dimensioned to be received by the receiver 125 of the movable component 120. The geometry of the converter protrusion 135 may be cylindrical, splined, keyed, or star-shaped to match the geometry of the receiver 125, ensuring a non-slipping engagement for accurate angular transmission. Therefore, as the movable component 120 rotates in response to movement of the hinge assembly H, this rotational motion is transferred directly through the converter protrusion 135 to the internal sensor 131 of the converter 130.

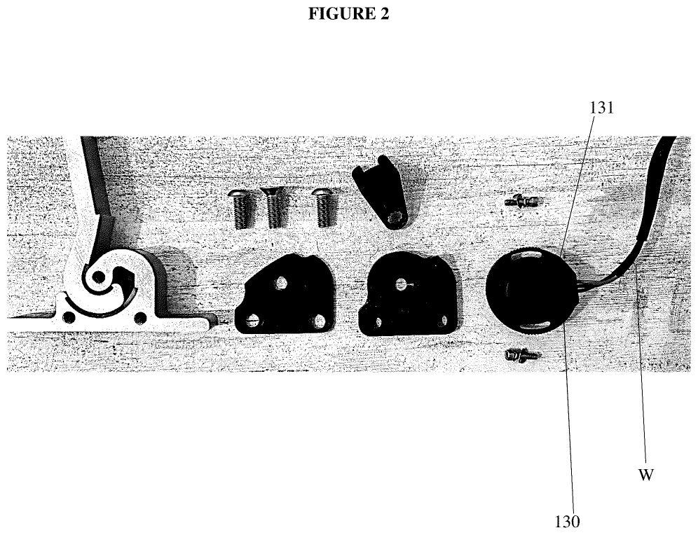

Turning briefly to FIG. 2, the converter 130 is shown in a flipped orientation, such that the outwardly facing or posterior surface is depicted. This side of the converter 130 may serve as the mounting interface or protective backplate and may include features for mechanical reinforcement or sealing. Though the sensor 131 is labeled in FIG. 2, it is not directly visible because it may reside within an internal cavity of the converter 130. The sensor 131 may be any form of rotational or angular position sensor—such as a Hall-effect sensor, optical encoder, or magnetic encoder—capable of detecting the arc length through which the converter protrusion 135 rotates. This arc length corresponds to the angular displacement of the hinge assembly H or rotation about the central axis C.

The sensor 131 may be operatively connected to wiring W, which transmits electrical signals corresponding to the detected arc length. The wiring W may extend from the converter 130 and terminate in a plug or connector compatible with marine data systems, such as those conforming to the NMEA 2000 standard. In this manner, the mechanical movement captured by the movable component 120 and passed to the converter 130 is ultimately converted into digital data that can be read, stored, or visualized through onboard marine electronics.

Together, the structural and electrical integration of the converter 130, converter protrusion 135, sensor 131, and wiring W enables precise, real-time monitoring of the angular position of a hinge-based marine bracket without the need for invasive modifications or recalibration.

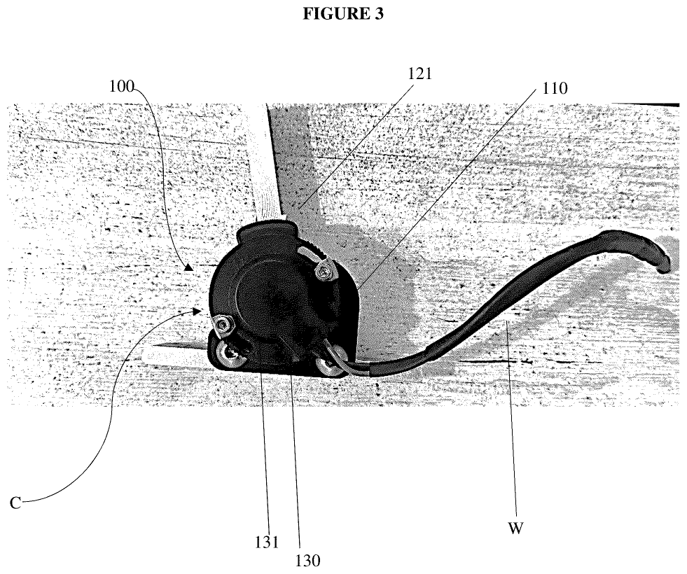

As such, with reference now to FIG. 3, the Figure is a front view of a mechanical sending unit base 100 installed on a hinge assembly H. As may be apparent, the stationary component 110 is affixed to the hinge assembly H via fasteners, whereas the moveable component 120 is between the stationary component 110 and the converter 130, the converter 130 being affixed to the stationary component 110 via fasteners F. As may be noted, the moveable component's 120 arm 121 extends beyond the converter 130, allowing the arm notch 122 to affix to a potion of the hinge assembly H. In this regard, FIG. 4 may be referenced, as it depicts an alternative view of that which is depicted in FIG. 3. As such, with continued reference to FIG. 4, the central axis C can be seen, noting that rotation of components is centered about this central axis C. Further, the arrangement or orientation of components can also be noted, the hinge assembly H acting as base, the washer 101 following, followed by the stationary component 110, moveable component 120, and converter 130.

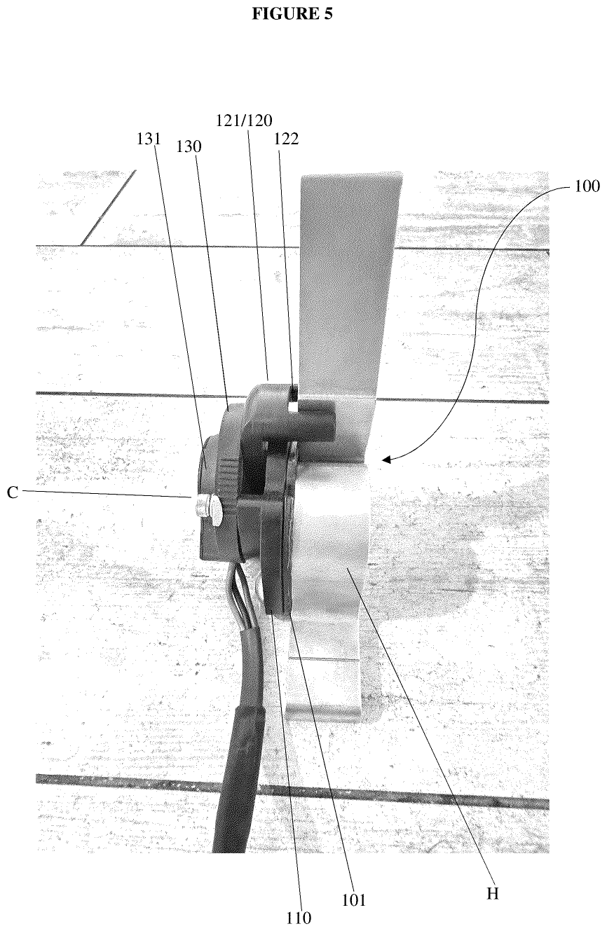

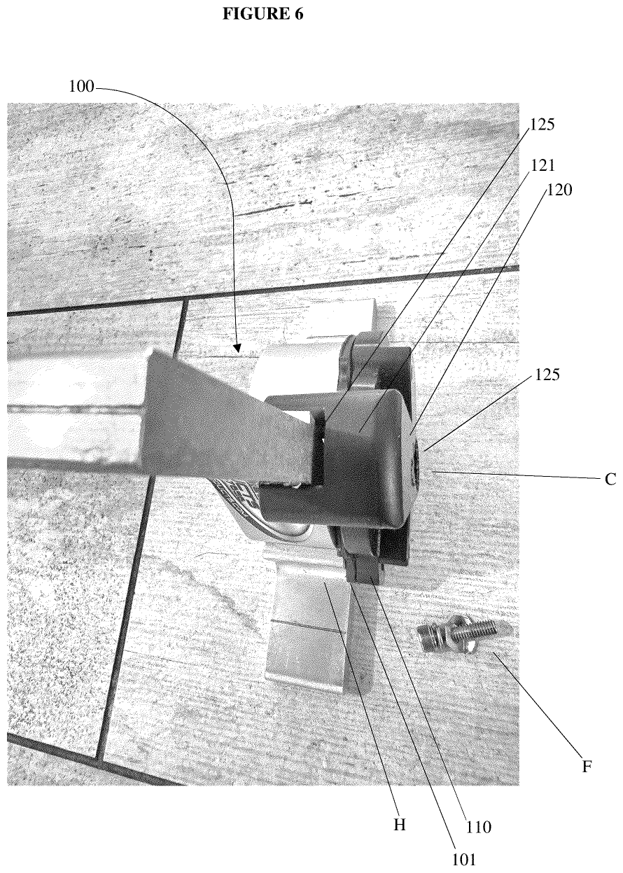

FIG. 5 can further be referenced, which is a backside view of FIG. 4. FIG. 5 can specifically be used to determine how a movable component 120 and the arm notch 122 can be affixed to a portion of the hinge assembly H. As such, it can be noted that the arm notch 122 may wrap about a portion of the hinge assembly H. FIG. 6 can also be referenced for the same reason, although FIG. 6 does not depict a converter 130 affixed to the stationary component 110, allowing for a depiction of how the moveable component 120 may be oriented about the stationary component 110.

Continuing, FIG. 7 can be referenced to determine how a converter protrusion 125 may fit within the receiver 125 as the figure depicts the converter 130 as removed from a partially assembled unit base 100. As such, it can be noted that the protrusion 125 comprises a specific geometry (such as grooves and valleys) so as to be received by the receiver 125 and also be rotated by the moveable component 120 based on the geometry. Further, the track or maximum lengths of travel is defined upon the stationary component 110, which determines the length about which the moveable component 120 may rotate. FIG. 8 may also be referenced for this functionality.

It is intended that all matters in the foregoing disclosure and shown in the accompanying drawings be interpreted as illustrative and not in a limiting sense.

What is claimed is:

1. A mechanical sending unit base comprising:
a stationary component and a movable component,
said stationary component immovably affixed to a hinge assembly, and
said movable component partially nestled within said stationary component and covered by a converter.

2. The mechanical sending unit base of claim 1 wherein said stationary component becomes immovably affixed to a hinge assembly via at least one fastener.

3. The mechanical sending unit base of claim 2 wherein a washer is interposed between said stationary component and the hinge assembly when said stationary component is immovably affixed to the hinge assembly via said at least one fastener.

4. The mechanical sending unit base of claim 1 wherein said movable component comprises an arm, configured and dimensioned to affix to a portion of the hinge assembly, and a receiver.

5. The mechanical sending unit base of claim 4 wherein said receiver comprises a dimensioning able to be received by a converter protrusion of said converter.

6. The mechanical sending unit base of claim 5 wherein said stationary component further comprises converter attachment points configured and dimension to allow said converter to affix to said stationary component and cover said movable component when affixed to said stationary component.

7. The mechanical sending unit base of claim 6 wherein when a portion of the hinge assembly rotates about a central axis, said arm allows said receiver to rotate about said central axis at an arc length equal to the portion of the hinge assembly's rotation about said central axis.

8. The mechanical sending unit base of claim 7 wherein when a portion of the hinge assembly rotates about said central axis, causing said arm to allow said receiver to rotate about said central axis at an arc length equal to the portion of the hinge assembly's rotation about said central axis, said converter protrusion rotates about said central axis at an arc length equal to the portion of the hinge assembly's rotation about said central axis.

9. The mechanical sending unit base of claim 8 wherein said converter comprises a sensor configured to measure an arc length when said converter protrusion rotates about said central axis and convert the arc length to machine readable data.

10. The mechanical sending unit base of claim 9 wherein the machine-readable data may be read on a NM EA 2000 network.

11. The mechanical sending unit base of claim 1 wherein said stationary component, said movable component, and said converter comprise bodies made of rigid plastic.

12. A mechanical sending unit base comprising:
a stationary component and a converter,
a movable component nestled between said stationary component and said converter,
a central axis upon which a receiver of said movable component and a converter protrusion of said converter may rotate about, and
wherein said stationary component is immovably affixed to a hinge assembly.

13. The mechanical sending unit base of claim 12 wherein said stationary component comprises a track about which said movable component may move about.

14. The mechanical sending unit base of claim 12 wherein said receiver of said movable component is configured to receive said converter protrusion of said converter.

15. The mechanical sending unit base of claim 14 wherein said movable component comprises an arm configured and dimensioned to affix to a portion of the hinge assembly.

16. The mechanical sending unit of claim 15 wherein when a portion of the hinge assembly rotates about said central axis at an arc length, said arm rotates about said central axis wherein said receiver, and consequentially, said converter protrusion, rotates an arc length equal in distance as the arc length rotated by the hinge assembly.

17. The mechanical sending unit of claim 16 wherein said converter comprises a sensor configured to convert an arc length traveled by said converter protrusion into machine readable data that may be read on a NMEA 2000 network.

18. The mechanical sending unit of claim 12 wherein said stationary component comprises an aperture pattern dimensioned to align with that of a Porta Bracket.

19. The mechanical sending unit of claim 18 wherein said Porta Bracket comprises said hinge assembly.

20. The mechanical sending unit base of claim 12 wherein the geometries of said stationary component, said converter, and said movable component are formed of a corrosion-resistant material suitable for marine environments.
